(19) United States
(12) Patent Application Publication
(10) Pub. No.: US 2006/0198031 A1
(43) Pub. Date: Sep. 7, 2006

(54) OBJECTIVE LENS AND OPTICAL RECORDING AND/OR REPRODUCING APPARATUS HAVING THE SAME

(76) Inventor: Ga-Lane Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,923

(22) Filed: Jan. 17, 2006

(30) Foreign Application Priority Data
Feb. 28, 2005 (CN) 200510033406.0

(51) Int. Cl. G02B 3/02

(52) U.S. Cl. 359/719

(57) ABSTRACT

An objective lens (10) is made of ceramic material. The ceramic material has a relatively high refractive index (i.e., more than 2.0), and this ensures that the objective lens has a relatively high numerical aperture (NA) (i.e., more than 2.0). An optical recording and/or reproducing apparatus includes the above-described objective lens, a laser emitter (22), a collimating lens (24), a splitter (26), a converging lens (28) and an optical detector (30). A laser beam emitted from the laser emitter is collimated by the collimating lens and is split by the splitter. The split laser beam is converged by the objective lens to a disk. Because the numerical aperture of the objective lens is relatively high, a focus spot of the split light on the disk is relatively small. Therefore, the optical recording and/or reproducing apparatus has excellent optical performances.

### FIELD OF THE INVENTION

The invention relates generally to objective lenses and optical recording and/or reproducing apparatuses having the same; and more particularly, to an objective lens having a high refractive index, and an optical recording and/or reproducing apparatus having the same.

### DESCRIPTION OF RELATED ART

Optical recording and/or reproducing apparatuses are used to record information into an optical recording and/or reproducing medium, such as an optical disk or a photo-electro-magnetic disk, and read information stored therein, by means of laser beams. A typical optical recording and/or reproducing apparatus generally includes a laser emitter, a collimating lens, a splitter, an objective lens, a converging lens and an optical detector. The laser emitter is used to emit a laser beam. The collimating lens is used to collimate the laser beam. The splitter is used to split the collimated laser beam. The objective lens is used to converge the split laser beam to the disk. The converging lens is used to converge the reflected laser beam from the disk. The optical detector is used to receive the converged laser beam and convert the converged laser beam into electrical signals.

In a reading operation, the laser emitter emits a low-power laser beam. The low-power laser beam is collimated by the collimating lens, split by the splitter and then converged on the disk by the objective lens. After that, the low-power laser beam is reflected by the disk and is transmitted through the objective lens and the splitter in turn. Finally, the reflected laser beam is converged by the converging lens and received by the optical detector. The optical detector converts the received laser beam into electrical signals containing information recorded on the disk.

In a recording operation, the laser emitter emits a high-power laser beam. The high-power laser beam containing information is collimated by the collimating lens, split by the splitter and then converged on the disk by the objective lens. Therefore the information is recorded into the disk.

In order to enhance the storage capacity of the disk, a size of the focus spot formed by the objective lens must be as small as possible. As shown in FIG. 3, a diameter D of the focus spot formed by the conventional objective lens 100 is proportional to a wavelength of the laser beam and inversely proportional to the NA of the objective lens 100 (i.e., D ∝ λ/NA, wherein, λ represents the wavelength of the laser beam emitted from the laser emitter). That is to say, for making the disk to be of a high density type, there is a method to make the wavelength of the laser beam emitted from the laser emitter to be as short as possible, in addition to a method to make the NA of the objective lens 100 to be as high as possible.

Conventionally, the storage capacity of the disk is enhanced by making the wavelength of the laser beam emitted from the laser emitter to be short. For example, the earliest generation disks, such as CDs (compact disks) adopt a laser beam with a wavelength of about 780 nanometers, and a storage capacity thereof is about 680 MB. The following generation disks, such as DVDs (digital versatile disks) adopt a laser beam with a wavelength at about 650 nanometers, and a storage capacity thereof is about 4.7 GB. The next generation disks, such as HD-DVDs (high-density digital versatile disks) or Blue ray disk adopts a laser beam with a wavelength in the range from 405 nanometers to 410 nanometers, and a storage capacity thereof is about 20 GB.

It can be concluded from the above description, the storage capacity of the disk can't be further enhanced by further decreasing the wavelength of the laser beam emitted from the laser emitter. Therefore, the method to make the NA of the objective lens to be as high as possible should be adopted to further enhance the storage capacity of the disk.

Referring to FIG. 3, the NA of the objective lens 100 is equal to n*sin(θ₁/2) (i.e., NA=n*sin(θ₁/2), wherein n is a refractive index of the objective lens 100, and θ₁ is an aperture angle of the objective lens 100). That is, the NA of the objective lens 100 is proportional to the refractive index n of the objective lens 100 and the aperture angle θ₁ of the objective lens 100. Thus, for making the NA of the objective lens 10 to be as high as possible, there is a method to increase the refractive index n of the objective lens 100, in addition to a method to increase the aperture angle θ₁ of the objective lens 100.

Referring to FIG. 4, an objective lens group 200 is disclosed to enhance the NA thereof. The objective lens group 200 includes a first lens 202 and a second lens 204. A laser beam is firstly focused by the first lens 202 and then further focused by the second lens 204. As shown in FIG. 4, an aperture angle θ₂ of the objective lens group 200 is bigger than an aperture angle θ₃ of the single first lens 202. Thus, the NA of the objective lens group 200 is enhanced.

The objective lens group 200 has the relatively high NA, but it has two lenses 202, 204. This results in the optical recording and/or reproducing apparatus adopting the objective lens group 200 has a relatively large bulk and a relatively high cost. Therefore, the method to increase the aperture angle of the objective lens to enhance the NA thereof is unsatisfactory.

Thus, another method to increase the refractive index n of the objective lens is studied. Conventionally, the objective lens is made of a material selected from a group consisting of glass and plastic. A refractive index of the glass or plastic is in the range from 1.45 to 1.85. Correspondingly, an NA of the objective lens used in the CDs is about 0.45, and an NA of the objective lens used in the DVDs is about 0.6. Furthermore, an NA of the objective lens used in the next generation disks, such as HD-DVDs (high-density digital versatile disks) or Blue ray disk is required to be about 0.85. Thus, a material adopted by the HD-DVDs (high-density digital versatile disks) or Blue ray disk must be more than 2.0. Therefore, the glass or plastic can't meet this requirement.

What is needed, therefore, is an objective lens made of a material having a high refractive index.

What is also needed is an optical recording and/or reproducing apparatus adopting the above-mentioned objective lens.

### SUMMARY OF INVENTION

In one embodiment, an objective lens is made of ceramic material. The ceramic material has a relatively high refractive index (i.e., more than 2.0), and this ensures that the objective lens has a relatively high numerical aperture (NA).

In another embodiment, an optical recording and/or reproducing apparatus includes the above-described objective lens, a laser emitter, a collimating lens, a splitter, a converging lens and an optical detector. A laser beam emitted from the laser emitter is collimated by the collimating lens and is split by the splitter. The split laser beam is converged by the objective lens to a disk. Because the numerical aperture of the objective lens is relatively high, a focus spot of the split laser beam on the disk is relatively small. Therefore, the optical recording and/or reproducing apparatus has excellent optical performances.

Other advantages and novel features of the present objective lens and the related optical recording and/or reproducing apparatus will become more apparent from the following detailed description of preferred embodiments when taken in conjunction with the accompanying drawings.

### BRIEF DESCRIPTION OF DRAWINGS

Many aspects of the present objective lens and the related optical recording and/or reproducing apparatus can be better understood with reference to the following drawings. The components in the drawings are not necessarily to scale, the emphasis instead being placed upon clearly illustrating the principles of the present objective lens and the related optical recording and/or reproducing apparatus.

FIG. 1 is a schematic, side view of an objective lens in accordance with a preferred embodiment of the present device, showing an optical path relating thereto;

FIG. 2 is a schematic, side view of an optical recording and/or reproducing apparatus adopting the objective lens of FIG. 1, showing an optical path relating thereto;

FIG. 3 is a schematic, side view of a conventional objective lens, showing an optical path relating thereto; and

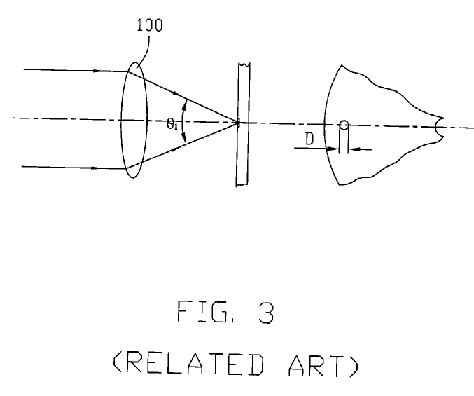

FIG. 4 is a schematic, side view of a conventional objective lens group, showing an optical path relating thereto.

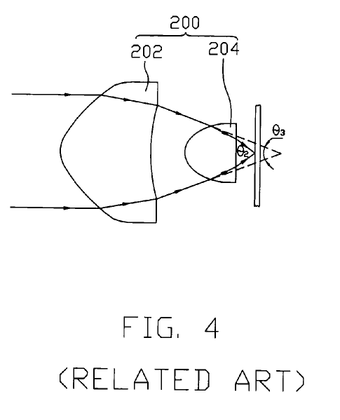

Corresponding reference characters indicate corresponding parts throughout the several views. The exemplifications set out herein illustrate at least one preferred embodiment of the present objective lens and the related optical recording and/or reproducing apparatus, in one form, and such exemplifications are not to be construed as limiting the scope of the invention in any manner.

### DETAILED DESCRIPTION

Reference will now be made to the drawings to describe embodiments of the present objective lens and the related optical recording and/or reproducing apparatus.

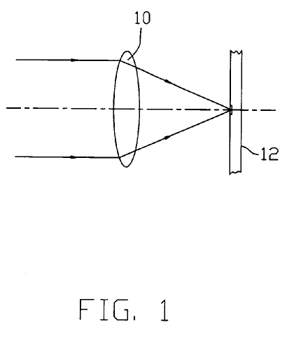

Referring to FIG. 1, an objective lens 10 in accordance with a preferred embodiment of the present device is made of ceramic material. The ceramic material mainly contains La₂O₃, Al₂O₃, CaO and TiO₂. In the preferred embodiment, the Al₂O₃ is γ- Al₂O₃. The γ- Al₂O₃ has a loose crystal lattice and a small bulk density. The TiO₂ is admixed with the γ- Al₂O₃ and is filled in gaps of the γ- Al₂O₃. The TiO₂ and the γ- Al₂O₃ are preferably integrally formed as a whole. As the TiO₂ has a relatively high refractive index, a refractive index of the ceramic material can be controlled to be more than 2.0 by adjusting the proportion by mass of the TiO₂ to the γ- Al₂O₃. Furthermore, La ions in the ceramic material provided by the La₂O₃ has a relatively large radius and a relatively high atomic nucleus field intensity. Thus, the La ions has a relatively large gathering force to electron clouds. This is favorable for enhancing a chemical stability of the ceramic material. CaO has a fluxing action during a burning process of the ceramic material. The γ- Al₂O₃ would convert into a- Al₂O₃ during the burning process (i.e., at a temperature of 950° C.-1500° C.) of the ceramic material. The α- Al₂O₃ is also referred to as corundum. The corundum has a high chemical stability, high melting point (i.e., about 2040° C.) and high rigidity (i.e., about Mohs 9°).

Therefore, a refractive index of the objective lens 10 made of the above-described ceramic material is more than 2.0. Furthermore, the objective lens 10 has a high melting point, high rigidity and high chemical stability. Furthermore, the TiO₂ can be replaced by Ta₂O₅. The Ta₂O₅ also has a relatively high refractive index.

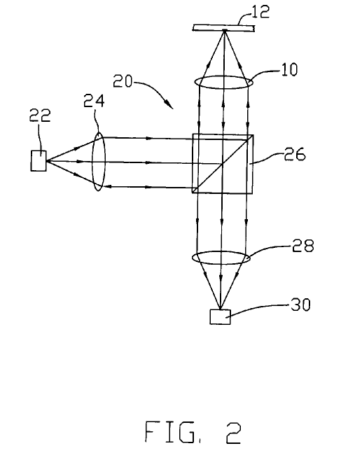

Referring to FIG. 2, an optical recording and/or reproducing apparatus 20 adopting the preferred objective lens 10 includes a laser emitter 22, a collimating lens 24, a splitter 26, a converging lens 28 and an optical detector 30. The laser emitter 22 is used to emit a laser beam. In the preferred embodiment, the laser beam is a blue ray with a wavelength in the range from 405 nanometers to 410 nanometers. The collimating lens 24 is used to collimate the blue ray. The splitter 26 is used to split the collimated blue ray. The objective lens 10 is used to converge the split blue ray to a disk 12. The converging lens 28 is used to converge the reflected blue ray from the disk 12. The optical detector 30 is used to receive the converged blue ray and convert the converged blue ray into electrical signals.

In a reading operation, the laser emitter 22 emits a low-power blue ray. The low-power blue ray is collimated by the collimating lens 24, split by the splitter 26 and then converged on the disk 12 by the objective lens 10. After that, the low-power blue ray is reflected by the disk 12 and is transmitted through the objective lens 10 and the splitter 26 in turn. Finally, the reflected blue ray is converged by the converging lens 28 and received by the optical detector 30. The optical detector 30 converts the received blue ray into electrical signals containing information recorded on the disk 12.

In a recording operation, the laser emitter 22 emits a high-power blue ray. The high- power blue ray containing information is collimated by the collimating lens 24, split by the splitter 26 and then converged on the disk 12 by the objective lens 10. Therefore information is recorded into the disk.

Compared with a conventional objective lens, the objective lens 10 of the present device has a relatively high numerical aperture. Thus, the focus spot on the disk 12 is relatively small. Furthermore, the defocus margin is inversely proportional to the square of the NA of the objective lens 100 (i.e., ∝ λ/(NA)²), the tilt margin is inversely proportional to the cube of the NA of the objective lens 100 (i.e., ∝λ/(NA)³), and the spherical aberration is inversely proportional to the fourth of the NA of the objective lens 100 (i.e., ∝λ/(NA)⁴). Thus the defocus margin and the tilt margin become better, and the spherical aberration is minimized. Therefore, the objective lens 10 has excellent optical performances, and the optical recording and/or reproducing apparatus 20 adopts the objective lens 10 thereby having excellent optical performances.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. An optical lens comprised of ceramic material, and a refractive index of the ceramic material being more than 2.0.

2. The optical lens as claimed in claim 1, being an aspherical lens.

3. The optical lens as claimed in claim 1, wherein the ceramic material is comprised of TiO₂.

4. The optical lens as claimed in claim 3, wherein the ceramic material is further comprised of Al₂O₃.

5. The optical lens as claimed in claim 4, wherein the ceramic material is further comprised of La₂O₃ and CaO.

6. The optical lens as claimed in claim 1, wherein the ceramic material is comprised of Ta₂O₅.

7. The optical lens as claimed in claim 6, wherein the ceramic material is comprised of Al₂O₃.

8. The optical lens as claimed in claim 7, wherein the ceramic material is further comprised of La₂O₃ and CaO.

9. An optical recording and/or reproducing apparatus, comprising:
a laser emitter for emiting a laser beam;
a collimating lens for collimating the laser beam;
a splitter for splitting the collimated laser beam;
an objective lens for converging the split laser beam to a disk, the objective lens being comprised of ceramic material and a refractive index of the ceramic material being more than 2.0;
a converging lens for converging the reflected laser beam from the disk; and
an optical detector for receiving the converged laser beam and converting the converged laser beam into electrical signals.

10. The optical recording and/or reproducing apparatus as claimed in claim 9, wherein the objective lens is an aspherical lens.

11. The optical recording and/or reproducing apparatus as claimed in claim 9, wherein the ceramic material is comprised of TiO₂.

12. The optical recording and/or reproducing apparatus as claimed in claim 11, wherein the ceramic material is further comprised of Al₂O₃.

13. The optical recording and/or reproducing apparatus as claimed in claim 12, wherein the ceramic material is further comprised of La₂O₃ and CaO.

14. The optical recording and/or reproducing apparatus as claimed in claim 9, wherein the ceramic material is comprised of Ta₂O₅.

15. The optical recording and/or reproducing apparatus as claimed in claim 14, wherein the ceramic material is further comprised of Al₂O₃.

16. The optical recording and/or reproducing apparatus as claimed in claim 15, wherein the ceramic material is further comprised of La₂O₃ and CaO.
